(19) United States
(12) Patent Application Publication
(10) Pub. No.: US 2005/0147823 A1
(43) Pub. Date: Jul. 7, 2005

(54) Treatment of porous filler materials for use with resins

(76) Inventors: Mark Oliver, Auckland (NZ); Oliver Charles Graham Jackson-Hill, Hamilton (NZ)

Correspondence Address: LADAS & PARRY LLP, 224 SOUTH MICHIGAN AVENUE, SUITE 1200, CHICAGO, IL, 60604, US

(21) Appl. No.: 10/747,434

(22) Filed: Dec. 29, 2003

(51) Int. Cl. B32B 5/16; B05D 7/00

(52) U.S. Cl. 428/407; 427/372.2; 427/222

(57) ABSTRACT

A treatment of organic plant-based filler materials to prevent the filler materials from absorbing resin. The filler material is treated by soaking in a solution of resin blocker. The filler material is then moved from the resin blocker solution and dried before use with the resin.

### FIELD OF THE INVENTION

The present invention relates generally to the treatment of porous filler materials used as a filler component in resin compositions. More specifically, the present invention relates to the treatment of organic plant-based materials for use as a filler component in a polyester resin laminate.

### BACKGROUND OF THE INVENTION

It is well known to use filler materials in conjunction with resins. The filler materials may offer many advantages such as reduced cost of the resin composition, increased strength, lower weight, increased durability, modified stiffness, increased flexibility, fire retardancy, modified acoustical properties, etc. Since resins typically are very expensive, of great interest is the cost savings the use of fillers may provide. Organic plant materials such as sawdust, wood chips and plant fibers are widely available as a by-product of manufacturing processes, and at a low cost.

Resins typically are also used in laminates with layers of fiber mats used to provide structural integrity to the laminate. Mats, such as fiberglass mats, must be completely surrounded by the resin including between the fibers of the mat, for maximum structural support, and to provide the desired smooth surface over the surface of the laminate. This is called “wetting” the mat. Insufficient resin, voids or air gaps in the cured resin weakens the formed piece and ruins the desired smooth finished surface. However, it was discovered that porous resin filler materials, especially plant-based materials, may absorb a portion of the resin within the material itself. This absorption can draw resin away from laminated mats before the resin can cure, resulting in insufficient resin, voids or air gaps in the composite. This has been described as secondary absorption.

Primary absorption of resin by the filler material occurs almost immediately when the resin is combined with the filler material. Primary absorption is caused by the resin filling the open spaces on and around the filler material. Secondary absorption occurs much more slowly and is caused by the resin being absorbed within the boundaries of the filler material itself. Secondary absorption can be observed after wet out, but before full cure. Thus, resins in which a porous filler material is used commonly experience non-complete wetting of the mats and voids within the cured resin. This problem is avoided by using filler materials that do not absorb resin. However, non-absorbent filler materials typically are more expensive than porous filler materials, such as plant materials and some recycled plastics and mineral materials. Thus, the need exists for a low cost filler material that does not absorb resin, at least secondarily.

### SUMMARY OF THE INVENTION

The present invention is a pre-treatment of organic plant-based filler materials which solves the foregoing problem of secondary absorption of resin, by the filler, before the resin can cure. The plant filler material is treated with a resin blocking compound and then dried. The filler material thus treated with the resin blocker may be used with the resin without any appreciable secondary absorption of the resin by the filler material. This reduces the amount of resin consumed, and solves the problem of the resin being drawn away from a laminate during the curing process.

It is preferred to use a plant derived filler material such as wood chips, sawdust and plant fibers, since the plant material may be obtained at a low cost. Consideration must be given to choose a resin blocker and resin combination which do not react with each other. A resin blocker which works to block one type of resin may not necessarily work with another type of resin due to adverse reactions between the two.

### DETAILED DESCRIPTION OF THE PREFERRED EMBODIMENT

For most applications it is desirable to provide a filler material, resin and resin blocker combination at a low cost. The described preferred embodiment achieves a low cost combination. However, it is understood that other combinations may also equally be used if a combination having enhanced properties is desired.

In a preferred embodiment wood is used as the filler material. The size of the wood particles may be very fine, such as sawdust, or larger wood chips, and is limited by the size of the article which is being fashioned by the resin/filler compound, the desired strength of the cured resin/filler compound, and possibly the method used to produce the article.

Wood and other plant materials have a very porous cellular structure which readily absorbs resin. As before described, secondary absorption of the resin by a filler material creates voids and air gaps in the cured resin/filler compound, and will draw resin away from a fiber mat when used in a laminate.

To prevent the absorption of resin by the filler material, the filler material is treated with a resin blocker. However, selection of the resin blocker depends on the resin which is being used. A resin blocker which adversely reacts with the selected resin could affect the proper cure and strength of the resin.

In this embodiment a polyester resin is used for its low cost and wide use in the industry. It was discovered that treatment of the wood filler material with an acrylic emulsion effectively blocked absorption of the polyester resin and did not cause any adverse reactions between the resin and resin blocker.

To treat the wood filler material, the wood filler material is soaked in an acrylic emulsion solution and then allowed to dry. The use of a concentrated acrylic emulsion solution is expensive. The resin blocking performance can be achieved using a wide range of acrylic emulsion concentrations, from a concentrated emulsion down to a weak solution in water, using sufficient volume of the solution to saturate the resin filler material. However, the more diluted the acrylic emulsion solution, the longer the drying time of the wood filler material. The resin filler material is dried to remove any moisture that could inhibit the subsequent cure of the resin/filler composite. The duration of the drying process can vary widely depending on the nature of the oven, and the concentration of the solution.

A preferred method uses REVACRYL 269™, a thermoplastic styrene acrylate emulsion manufactured by Nuplex Industries Limited of New Zealand, as the acrylic emulsion in the treatment process. A cost effective solution of REVACRYL 269™ for the treatment of wood filler material is 10% by weight of REVACRYL 269™ (when supplied at 50% solids content) compared to the weight of wood filler material to be treated, and the REVACRYL 269™ diluted by water. Typically 3 liters of the REVACRYL 269™/water solution is provided for each kilogram of wood filler material. The wood filler material is immersed and stirred in the solution until there is no more absorption of the solution by the resin filler material, this can take approximately five minutes. Drying is achieved using an air recirculation oven, with the air temperature at 35° C. for a period of two days. However much faster times have been realized using higher oven temperatures and the nature of the drying process.

The thus treated wood filler material may be used in conjunction with a resin, limiting the absorption of the resin by the filler material. The filler material may be used alone or as a core in a laminate.

One particular use of the treated wood filler material is as a core layer of a composite laminate. In a typical laminate a core of filler material is sandwiched between two or more layers of a fiber laminate (typically fiberglass). The overlying layers of fiber laminate and core filler material could then be placed in a mold through which a resin is infused. The resin is then at least partially cured before the mold is opened. Examples of these closed molding preform processes include resin transfer molding, RTM light, vacuum infusion, and injection compression holding.

As previously discussed, when a resin filler material that is absorptive is used as a core in a preforming process, the secondary absorption of the resin by the filler material draws the resin away from outer layers of the fiber laminate, thus creating gaps or voids in the resin and incomplete wetting of the fiber laminate. This problem is solved by the use of a resin filler material that is treated to prevent any significant secondary absorption by the filler material.

As will be apparent to those skilled in the art to which the invention is addressed, the present invention may be embodied in forms other than those specifically disclosed above, without departing from the spirit or essential characteristics of the invention. The particular embodiment of the invention described above and the particular details of the processes described are therefore to be considered in all respects as illustrative and not restrictive. The scope of the present invention is as set forth in the appended claims rather than being limited to the examples set forth in the foregoing description. Any and all equivalents are intended to be embraced by the claims.

1. A method of treating a porous resin filler material, comprising the steps of:
providing the resin filler material;
immersing the resin filler material in a resin blocker solution;
removing the resin filler material from the resin blocker solution; and
drying the resin filler material.

2. The method of claim 1 wherein the resin filler material is a plant based material.

3. The method of claim 2 wherein the plant based filler material is wood.

4. The method of claim 2 wherein the resin blocker solution is an acrylic emulsion.

5. The method of claim 4 wherein the acrylic emulsion contains styrene acrylate.

6. The method of claim 4 wherein the resin blocker solution comprises a diluted solution of acrylic emulsion and provided in an amount such that the treated resin material is saturated by the solution.

7. The method of claim 1 wherein resin filler material is mixed with the resin blocker solution by stirring until the resin filler material is saturated by the resin blocker solution.

8. A resin and resin filler composite product comprising:
a porous resin filler treated with a resin blocker; and
a resin.

9. The product of claim 8 wherein the resin filler comprises a plant based material.

10. The product of claim 9 wherein the resin filler is wood.

11. The product of claim 9 wherein the resin blocker is an acrylic emulsion and the resin is a polyester resin.

12. The product of claim 11 wherein the acrylic emulsion contains styrene acrylate.

13. The product of claim 8 further comprising at least one fiber mat layer.

14. The product of claim 8 wherein said resin is applied to said treated resin filler in a resin transfer molding process.

15. The product of claim 8 wherein said resin is applied to said treated resin filler in an injection molding process.

16. The product of claim 14 wherein said resin and treated resin filler are further compressed within a mold.

17. The product of claim 15 wherein said resin and treated resin filler are further compressed within a mold.

18. The use of an acrylic emulsion solution to pretreat a plant-based resin filler material.
